(19) United States
(12) Patent Application Publication
(10) Pub. No.: US 2006/0112241 A1
(43) Pub. Date: May 25, 2006

(54) System, method and apparatus of securing an operating system

(76) Inventors: Yoav Weiss, Petach Tikva (IL); Aviram Yeruchami, Kfar Saba (IL)

Correspondence Address: PEARL COHEN ZEDEK, LLP, 1500 BROADWAY 12TH FLOOR, NEW YORK, NY, 10036, US

(21) Appl. No.: 11/286,362

(22) Filed: Nov. 25, 2005

Related U.S. Application Data
(60) Provisional application No. 60/630,301, filed on Nov. 24, 2004.

(51) Int. Cl. G06F 13/00

(52) U.S. Cl. 711/154; 713/2

(57) ABSTRACT

Embodiments of the present invention provide a method, apparatus and system of securing an operating system. The apparatus, according to some demonstrative embodiments of the invention, may include a memory access controller to receive from a processor a program counter representing a requested address of a memory to be accessed by the processor during a kernel mode of operation, and to selectively enable the processor to access the requested address based on a comparison between the requested address and one or more allowable addresses. Other embodiments are described and claimed.

### CROSS REFERENCE TO RELATED APPLICATIONS

This application claims priority from U.S. Provisional Application No. 60/630,301, filed Nov. 24, 2004, the entire disclosure of which is incorporated herein by reference.

### BACKGROUND OF THE INVENTION

Conventional computing platforms include a processor to execute instructions stored in a memory. The instructions may include kernel instructions to be executed during a Kernel mode of operation, and user instructions to be operated during a User mode of operation. During the Kernel mode of operation the memory may be directly accessed, handle inter-process communication, and the configuration of a Memory Management Unit (MMU) table defining memory addresses to be used by each of the applications may be controlled.

Conventional computing platforms may implement one or more security schemes for protection against malicious attacks. However, the computing platform may be attacked during the Kernel mode of operation, e.g., because conventional security schemes do not differentiate between a trusted code and a malicious and/or unauthorized code during the Kernel mode of operation.

Furthermore, certain internal “bugs” in the kernel instructions may be maliciously exploited to execute a hostile code and/or program during the Kernel mode of operation.

### SUMMARY OF SOME EMBODIMENTS OF THE INVENTION

Embodiments of the present invention provide a method, apparatus and system of securing an operating system.

According to some demonstrative embodiments of the invention an apparatus may include a memory access controller to receive from a processor a program counter representing a requested address of a memory to be accessed by the processor during a kernel mode of operation, and to selectively enable the processor to access the requested address based on a comparison between the requested address and one or more allowable addresses.

According to some demonstrative embodiments of the invention, the memory access controller may enable the processor to access the requested address during the kernel mode only if the requested address corresponds to one of the allowable addresses.

According to some demonstrative embodiments of the invention, the apparatus may include a storage to store one or more address values identifying the one or more allowable addresses.

According to some demonstrative embodiments of the invention, the apparatus may include a boot module to update the address values during a boot process to identify one or more memory addresses including boot instructions.

According to some demonstrative embodiments of the invention, the apparatus may include a debugging controller to perform an authentication of an attempt to operate the processor at a debugging mode, and to disable a debugging connection to the processor if the authentication fails.

According to some demonstrative embodiments of the invention, the allowable addresses may include one or more private addresses. The secure storage may store one or more type values indicating whether one or more of the allowable addresses include private data. The memory access controller may selectively enable the processor to access the requested address based on a type value of a private address corresponding to, e.g., matching, the requested address.

According to some demonstrative embodiments of the invention, the allowable addresses may include at least one atomic address range having an entry-point address. If the requested corresponds to the atomic address range, then the access controller may enable access to the requested address, for example, if the requested address corresponds to the entry-point address, or if a previously accessed address corresponded to the atomic address range.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic block-diagram illustration of a computing platform including a memory access-control configuration according to some demonstrative embodiments of the invention;

FIG. 2 is a schematic illustration of a flow chart of a method of loading a kernel according to some demonstrative embodiments of the invention;

FIG. 3 is a schematic illustration of a flow chart of a method for preventing an attempt to bypass one or more aspects of a protection scheme, according to some demonstrative embodiments of the invention;

FIG. 4a is a schematic illustration of a flow chart of a method of controlling access to a memory according to a demonstrative embodiment of the invention;

FIG. 4b is a schematic illustration of a flow chart of a method of controlling access to a memory according to another demonstrative embodiment of the invention;

FIG. 5 is a conceptual illustration of a kernel configuration according to some demonstrative embodiments of the invention; and

FIG. 6 is a conceptual illustration of a debugger authentication configuration according to some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Some embodiments of the invention may be implemented, for example, using a machine-readable medium or article which may store an instruction or a set of instructions that, if executed by a machine (for example, by a processor and/or by other suitable machines), cause the machine to perform a method and/or operations in accordance with embodiments of the invention. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

A Kernel mode of operation, as used herein, may refer to an Interrupt Request (IRQ) mode, a Fast Interrupt request (FIQ) mode, a supervisor (SVC) mode, and/or any one or more modes other than a User mode of operation, as is known in the art.

Some demonstrative embodiments of the invention include a method, device and/or system for securing an Operating System (OS), e.g., during a Kernel mode of operation, as described below.

The phrase “trusted kernel instructions” as used herein may refer to one or more instructions, which are determined, assumed, presumed, and/or recognized to be authorized instructions, certified instructions, approved instructions, and/or instructions that may not harm, destroy, and/or attack an OS during the Kernel mode of operation. Accordingly, the phrase “non-trusted kernel instructions” as used herein may refer to one or more instructions, which are not determined, assumed, presumed, and/or recognized to be authorized instructions, certified instructions, approved instructions, and/or instructions that may not harm, destroy, and/or attack an OS during the Kernel mode of operation.

According to some demonstrative embodiments of the invention, it may be desired to prevent execution, e.g., during the Kernel mode of operation, of one or more non-trusted kernel instructions. Thus, methods, devices and/or systems according to some demonstrative embodiments of the invention may determine one or more memory addresses containing one or more trusted kernel instructions (“access-allowable memory addresses”). The methods, devices and/or systems may restrict execution of instructions, e.g., during a Kernel mode of operation, to instructions stored in the one or more access-allowable memory addresses, as described in detail below.

Additionally or alternatively, it may be desired according to some demonstrative embodiments of the invention to selectively restrict the access to one or more memory addresses, e.g., containing private and/or secret information. Thus, methods, devices and/or systems according to some demonstrative embodiments of the invention, may selectively control access to one or more memory addresses, e.g., based on one or more criteria, as described below.

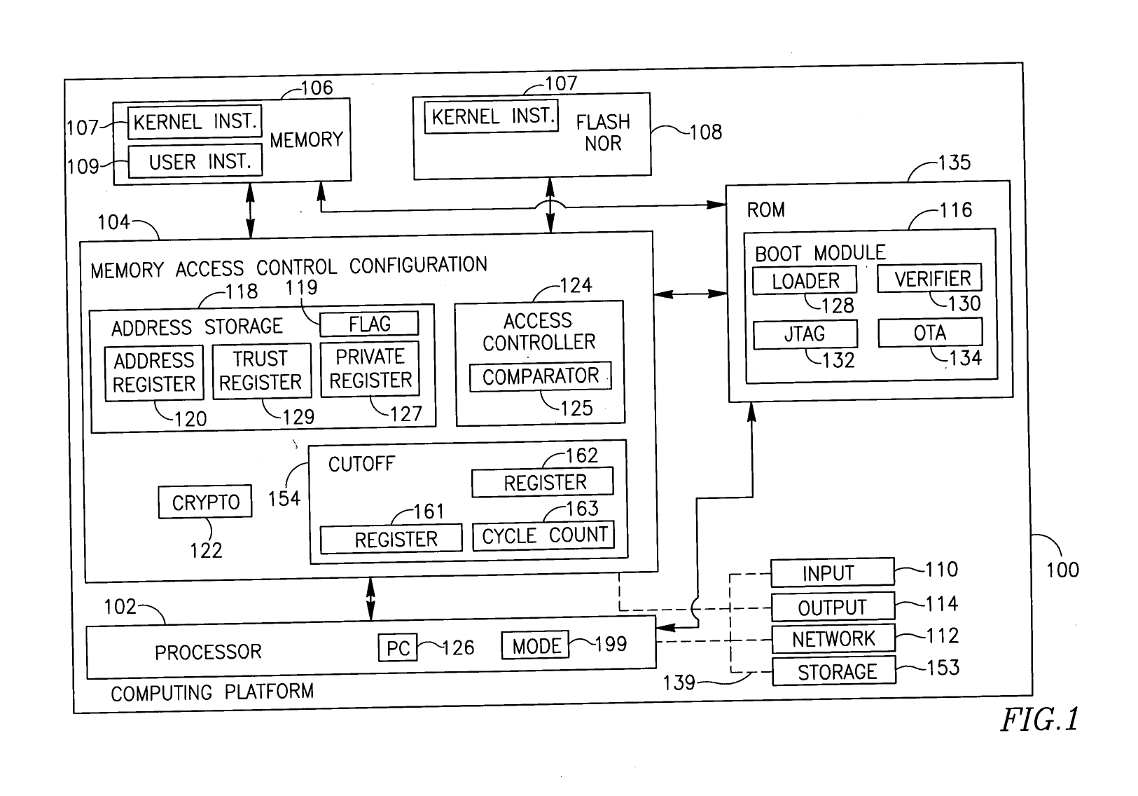

Reference is made to FIG. 1, which schematically illustrates a computing platform 100 according to some demonstrative embodiments of the invention.

Although the present invention is not limited in this respect, computing platform 100 may be a portable device. Nonlimiting examples of such portable devices may include mobile telephones, laptop and notebook computers, personal digital assistants (PDA), and the like. Alternatively, the computing platform may be a non-portable device, such as, for example, a desktop computer, a communication server, or one or more components of a “main frame” computer system.

According to the demonstrative embodiments of FIG. 1, computing platform 100 may include a processor 102, a memory 106, and, optionally, an output unit 114, an input unit 110, a network connection 112, and/or any other suitable hardware components and/or software components. Platform 100 may also include one or more communication links 139, e.g., a “bus” connection, to associate one or more hardware and/or software components of platform 100, as is known in the art.

Memory unit 106 may include, for example, a Random Access Memory (RAM), a Dynamic RAM (DRAM), a Synchronous DRAM (SD-RAM) or any other suitable memory units or storage units. Memory 106 may store, for example, one or more instructions executable by processor 102. The instructions may include, for example, one or more kernel instructions 107 to be executed by processor 102 during the Kernel mode of operation; and/or one or more user-mode instructions 109 to be executed by processor 102 during a User mode of operation, as known in the art. Computer platform 100 may optionally include one or more additional memories, e.g., a NOR flash memory 108, for storing one or more of the kernel instructions, as is known in the art. According to some demonstrative embodiments of the invention, the kernel instructions may be copied (“shadowed”) from NOR flash memory 108 to memory 106, e.g., during a Boot mode of operation, e.g., as described below.

Processor 102 may include a Central Processing Unit (CPU), a Digital Signal Processor (DSP), a microprocessor, a host processor, a plurality of processors, a controller, a chip, a microchip, or any other suitable multi-purpose or specific processor or controller. Processor 102 may include a Program Counter (PC) 126 to indicate an address of an instruction to be executed by processor 102, as is known in the art. For example, one or more instructions may be stored in a memory, e.g., memory 106 and/or memory 108, and PC 126 may include a register for storing the address in the memory of an instruction to be executed by processor 102. Processor 102 my also include a mode identifier 199 to identify the mode of operation of processor 102, as is known in the art. For example, mode identifier 199 may include a register to store a value indicative of the mode of operation of processor 102, as is known in the art.

According to some demonstrative embodiments of the invention, platform 100 may also include a memory access control configuration 104 to control access to memory 106 and/or memory 108, e.g., of processor 102 and/or one or more device-drivers, programs and/or files attempting to access memory 106 and/or memory 108 (hereinafter also referred to as “peripherals”) via links 139, as described below. For example, configuration 104 may be able to selectively allow access to one or more access-allowable addresses, e.g., of memory 106 and/or memory 108, during the Kernel mode of operation, and/or to selectively prevent access to one or more addresses other than the access-allowable addresses, as describe below.

According to some demonstrative embodiments of the invention, configuration 104 may include a storage configuration 118 to store one or more access-allowable addresses, e.g., in the form of a table of ranges corresponding to the access-allowable addresses. For example, storage configuration 118 may include a plurality of address registers 120 to store values corresponding to the access-allowable addresses. Configuration 118 may include, for example, one or more pairs of registers 120, each including a first register for storing a value corresponding to a beginning of a range of an access-allowable addresses and a second register for storing a value corresponding to the end of the range of addresses. According to some demonstrative embodiments of the invention, configuration 118 may include one pair of registers 120 to store values corresponding to one range of access-allowable addresses, e.g., if platform 100 implements a kernel stored in one range of addresses (“a monolithic kernel”). In other embodiments, configuration 118 may include any other suitable number of registers 120 to store values corresponding to two or more ranges of access-allowable addresses, e.g., if platform 100 implements two or more kernel elements stored in two or more ranges of addresses. Registers 120 may include any suitable register circuitry and/or other suitable hardware, e.g., as is known in the art.

According to some demonstrative embodiments of the invention, configuration 104 may also include an access controller 124 to restrict execution of instructions, e.g., during the Kernel mode of operation, to instructions stored in one or more of the access-allowable addresses of storage configuration 118. For example, controller 124 may include one or more comparators 125 to compare an address, e.g., received from PC 126 and/or from one or more peripherals, e.g., during the Kernel mode of operation, with one or more access-allowable addresses. Controller 124 may be able, for example, to restrict execution of instructions during the Kernel mode of operation to instructions stored in the access-allowable addresses of storage configuration 118. Comparators 125 may include any suitable logic circuitry and/or hardware, e.g., as is known in the art.

According to some demonstrative embodiments of the invention, memory access controller 124 may not allow changing and/or deleting any one or more of the kernel instructions, e.g., stored in the access-allowable addresses of memory 106 and/or memory 108.

According to some demonstrative embodiments of the invention, memory access controller 124 may allow adding to the kernel instructions one or more additional kernel instructions, e.g., corresponding to added programs and/or device-drivers, and updating the access-allowable addresses accordingly, as described below.

According to some demonstrative embodiments of the invention, controller 124 may control access, e.g., for read and/or write operations, to one or more addresses of memory 106 and/or memory 108 (“restricted-access addresses”), based on one or more criteria. For example, some memory addresses may be grouped into one or more classes, and controller 124 may selectively allow access to one or more of the classes, based on the one or more criteria, as described below.

According to some demonstrative embodiments of the invention, it may be desired to allow only one or more predetermined trusted operations to access one or more addresses of the access-allowable addresses (“trust-protected addresses”), and/or to allow only one or more predetermined private applications to access one or more addresses of the access-allowable addresses (“private addresses”), e.g., including Memory Management Unit (MMU) tables as are known in the art. For example, it may be desired to prevent external Direct Memory Access (DMA) to the private addresses.

According to some demonstrative embodiments of the invention, one or more of registers 120 may store values, e.g., indicative of address ranges, corresponding to one or more addresses (“protected memory addresses”), e.g., including addresses of kernel instructions and/or private addresses. Storage configuration 118 may optionally include a private-address register 127 to identify one or more of the access-allowable addresses as either private addresses or non-private addresses. For example, one or more bits of register 127 may store a value for identifying a corresponding protected address as either a private address or a non-private address.

According to some demonstrative embodiments of the invention, storage configuration 118 may optionally include a trust-address register 129 to store a trust value corresponding to one or more of the protected addresses. For example, one or more bits of register 129, e.g., corresponding to a memory address containing kernel instructions, may store a value corresponding to a trust level, e.g., of the corresponding kernel instructions. Similarly, one or more bits of register 129, for example, corresponding to a memory address containing data, may store a value corresponding to a trust level required for accessing the corresponding memory address, and/or a value identifying a corresponding access-allowable address as either a trust-protected address or a non-trust-protected address. According to some embodiments of the invention, register 129 may be capable of indicating whether data stored in a corresponding memory address is trust-protected or non-trust-protected. Additionally or alternatively, register 129 may be capable of indicating a trust level, e.g., selected from two or more different trust levels, of data stored in a corresponding memory address.

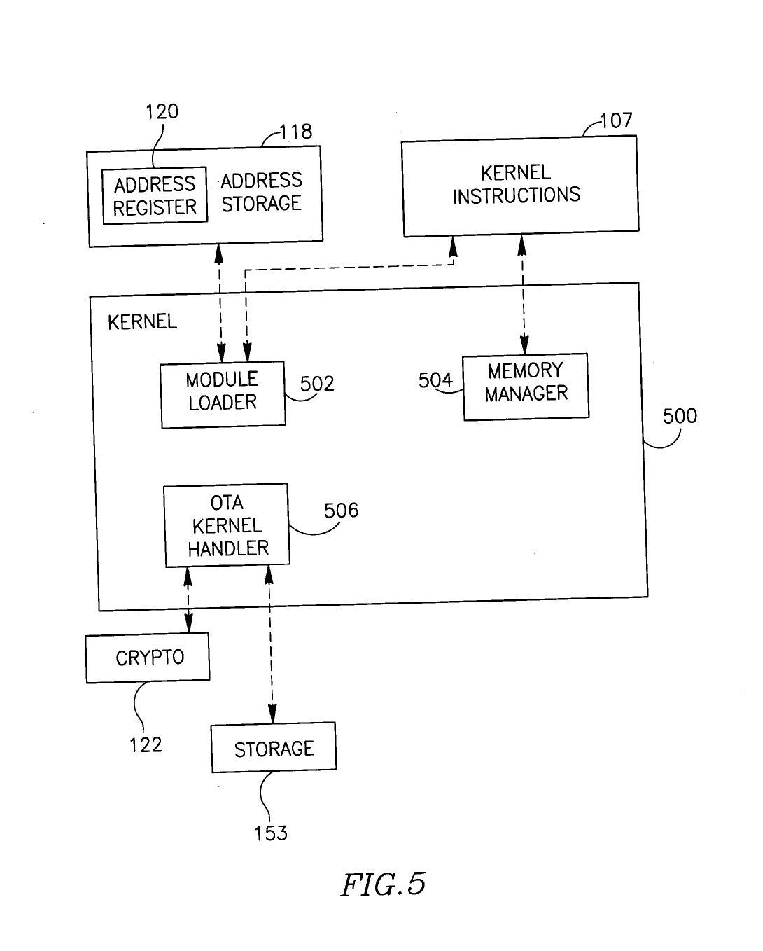

According to some demonstrative embodiments of the invention, one or more values stored in registers 127 and/or 129 may be added, modified, and/or deleted, e.g., during the Kernel mode of operation, e.g., by a memory manager module, as described below with reference to FIG. 5.

According to some demonstrative embodiments of the invention, storage configuration 118 may optionally include at least one atomic flag 119 corresponding to one or more of the protected addresses, e.g., one or more of the protected address ranges of registers 120. For example, flag 119 may correspond to a range of protected addresses including one or more kernel instructions intended to be executed as atomic instructions; and/or private data intended to be accessed by atomic instructions, e.g., as described below. Flag 119 may include, for example, a register able to store a first flag value, e.g., one, indicating a first flag mode (“flag up”), or a second flag value, e.g., zero, indicating a second flag mode (“flag down”). Access controller 124 may be able to set the value of flag 119, for example, as part of performing a write operation to registers 120, 129 and/or 127.

The term “atomic instructions” as used herein may refer to any set, sequence, combination, series, chain, collection, and/or group of instructions intended to be executed in a predetermined order, sequence, and/or combination, e.g., together and/or as a whole, such that, for example, the execution of the atomic instructions is intended to start only from a predetermined instruction, e.g., a first instruction; (“the atomic entry-point”) in of the atomic instructions, and is not intended to start, for example, from any instruction any other than the predetermined instruction.

According to some demonstrative embodiments of the invention, access controller 124 flag 119 may set flag 119 to the flag up mode, e.g., upon a request to access a first instruction in a set of atomic instructions. For example, access controller 124 may selectively set flag 119 to the flag up mode, e.g., upon receiving an address from PC 126 corresponding to the atomic entry-point address of an address range of registers 120 corresponding to flag 119. Access controller 124 may disable any external attempt, e.g., by any element external to configuration 104, to set the mode of flag 119 to the flag up mode.

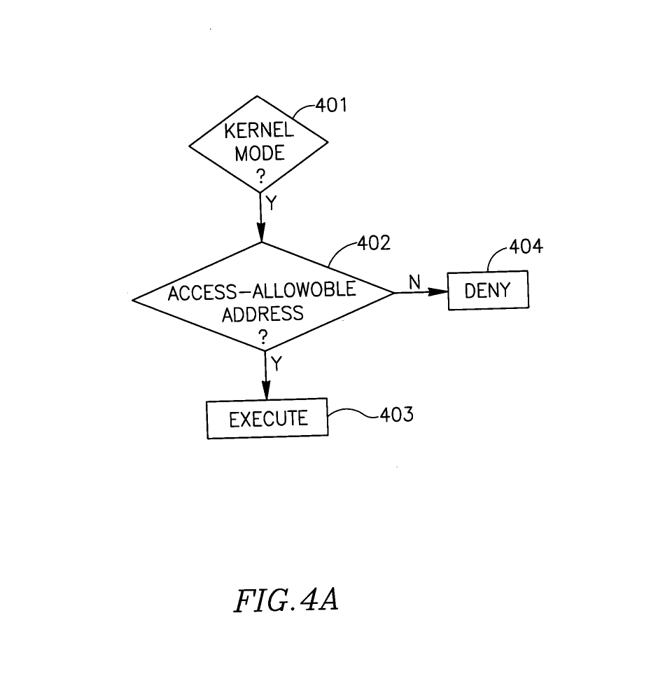

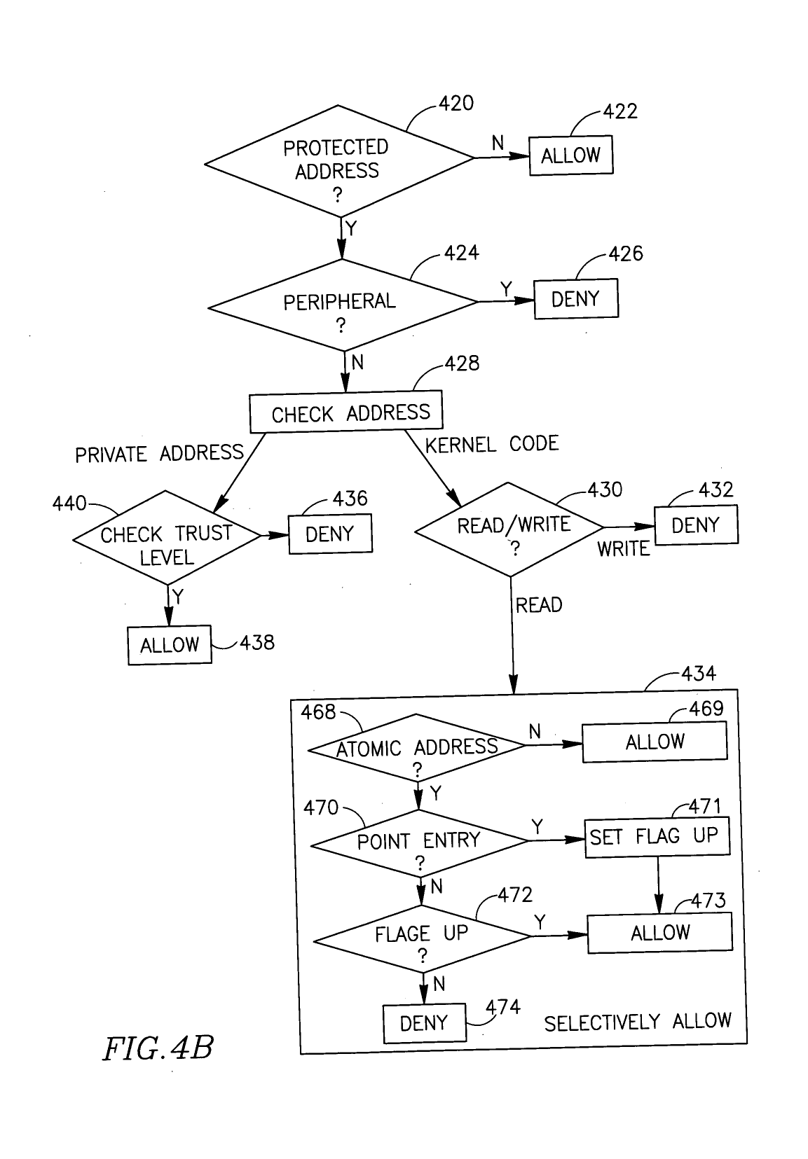

According to some demonstrative embodiments of the invention, flag 119 may be set to the flag down mode by access controller 124, and/or one or more of instructions 107 and/or 109, e.g., as described below with reference to FIG. 4B. Thus, for example, flag 119, when set to the flag-up mode may indicate, that or a previous attempt to enter another address within the requested atomic range was allowed.

According to some demonstrative embodiments of the invention, controller 124 may optionally be able to control access, e.g., for performing read and/or write operations, to the one or more protected addresses, based on the value of registers 127, 129 and/or register 119, as described below.

According to some demonstrative embodiments of the invention, configuration 104 may also include a cryptographic module 122 to verify a signature of a kernel and/or any other modules, drivers, programs or files; and/or for performing any other suitable cryptographic operations, as described below. Cryptographic module 122 may include any suitable circuitry, hardware and/or software, e.g., as is known in the art. For example, module 122 may include the CryptoCell™ available from Discretix Technologies Ltd., Israel.

According to some demonstrative embodiments of the invention, platform 100 may also include a boot module 116 able to load a kernel to memory 106 and/or update one or more of the access-allowable addresses, e.g., during a Boot mode of operation of platform 100.

Boot module 116 may include a kernel loader 128, and a kernel verifier 130, as are described in detail below. According to some demonstrative embodiments, boot module 116 may optionally include an Over The Air (OTA) update module 134 able to verify whether a replacement kernel is an authorized kernel and, if the replacement kernel is determined to be an authorized kernel, to replace a previous kernel with the replacement kernel, as described below.

According to some demonstrative embodiments of the invention, configuration 104 and/or module 116 may be adapted to verify that a kernel is an authorized kernel, to load the kernel to memory 106, and/or to update storage 118 with one or more values corresponding to one or more addresses in which the kernel is stored, as described below.

According to demonstrative embodiments of the invention, module 116 may be implemented, for example, by one or more boot instructions stored in a Read Only Memory (ROM) 135. According to these demonstrative embodiments, during the boot mode of operation, PC 126 may indicate an address at which the boot instructions are stored in ROM 135, and processor 102 may execute the boot instructions of ROM 135, as described below.

It is appreciated that debugging may be used for attacking the OS, e.g., during the boot mode of operation. For example, one or more boot instructions may be overridden, e.g., by providing the OS with instructions other than the boot instructions. This may result in an attack on the OS, for example, before the access-allowable addresses, e.g., of storage configuration 118, are properly updated. Some demonstrative embodiments of the invention are adapted to prevent such attacks on the OS. According to these demonstrative embodiments, it may be desired to authenticate a debugging attempt; and/or to cutoff a debugging attempt, which is not authenticated, e.g., before loading the kernel, as described below.

According to some demonstrative embodiments of the invention, configuration 104 may optionally include a cutoff module 154 able to selectively prevent unauthorized and/or un-trusted access of debugging attempts, for example, debugging attempts activating a Joint Test Action Group (JTAG) module and/or any other suitable debugging method, e.g., a boundary scan and/or an in-circuit debug method, during the boot mode of operation, as described below.

According to some demonstrative embodiments of the invention, cutoff module 154 may include first and second registers 161, and 162, respectively. Register 161 may include a read-only register, which may be, for example, preloaded with a value corresponding to data from a Random Number Generator (RNG) of cryptographic module 122. Register 162 may be adapted to store a Hashed Message Authentication Certificate (HMAC) value corresponding to the value of register 162 and to an authentication code corresponding to an authenticated debugger.

According to some demonstrative embodiments of the invention, cutoff module 154 may compare the values of registers 161 and 162, e.g., in order to verify debugging authentication, as described below. Cutoff module 154 may block (cutoff) a debugging attempt, e.g., a JTAG debugging attempt and/or any other debugging attempt, if debugging authentication fails, for example, if the value of register 162 does not correspond to the value of register 161, as described below.

According to some demonstrative embodiments of the invention, the access-allowable addresses may be updated during the boot mode of operation, as described below. It may be desired to block a debugging attempt if the loading of the kernel has not begun within a predetermined time period after platform 100 is activated (“power up”), e.g., in order to prevent a debugging attempt from overriding the boot instructions of boot module 116. According to some demonstrative embodiments of the invention, cutoff module 154 may also include a cycle counter 163, which may include a counter register, to store a cycle-count having a first, initial value, e.g., corresponding to at least the number of execution cycles performed between power-up and the loading of the kernel to the memory of platform 100. Counter 163 may also be able to decrease/increase the stored cycle-count, e.g., by one, for example, after each execution cycle of processor 102, as described below. According to some demonstrative embodiments of the invention, the cycle-count value may be repeatedly reduced/increased until the access-allowable addresses are updated, e.g., with the address of the boot instructions, as described below. Cutoff module 154 may be able to block a debugging attempt and/or to reset platform 100, e.g., if the cycle-count value reaches a second cycle-count value, e.g., zero, and the authentication of the debugging attempt has failed, as described below.

According to some demonstrative embodiments of the invention, boot module 116 may optionally include a JTAG authenticator 132 to request and/or receiving from a debugger an authentication code, e.g., a HMAC value, and storing the value in register 162.

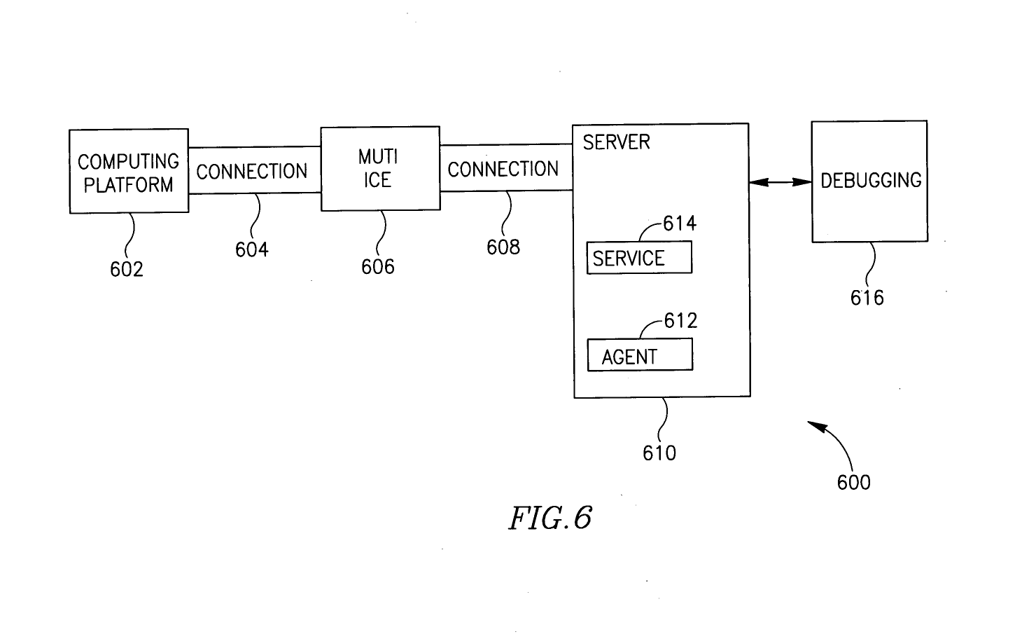

According to some demonstrative embodiments of the invention, it may be desired to receive, e.g., by authenticator 132, the authentication code from a debugger, e.g., a JTAG debugger, in a manner transparent to the debugger. According to some demonstrative embodiments, a debugger authentication agent may be implemented to perform the debugging authentication, as described below with reference to FIG. 6.

Aspects of the invention are described herein in the context of a demonstrative embodiment of a memory access controller, e.g., memory access controller 104, including a storage configuration, e.g., storage configuration 118, an access controller, e.g., access controller 124, a cutoff module, e.g., cutoff module 154, and a cryptographic module, e.g., cryptographic module 122. However, it will be appreciated by those skilled in the art that, according to other embodiments of the invention, any other combination of integrated or separate units may also be used to provide the desired functionality. For example, in some embodiments of the invention one or more of the storage configuration, the access controller, the cryptographic module and the cutoff module may be implemented as separate units of platform 100 and/or as part of other units of platform 100.

Input unit 132 may include, for example, a keyboard, a mouse, a touch-pad, or other suitable pointing device or input device. Output unit 133 may include, for example, a Cathode Ray Tube (CRT) monitor, a Liquid Crystal Display (LCD) monitor, or other suitable monitor or display unit. Network connection 112 may be adapted to interact with a communication network, for example, a local area network (LAN), wide area network (WAN), or a global communication network, for example, the Internet. According to some embodiments the communication network may include a wireless communication network such as, for example, a wireless LAN (WLAN) communication network. Although the scope of the present invention is not limited in this respect, the communication network may include a cellular communication network, with platform 100 being, for example, a base station, a mobile station, or a cellular handset. The cellular communication network, according to some embodiments of the invention, may be a 3^{rd} Generation Partnership Project (3GPP), such as, for example, Frequency Domain Duplexing (FDD), Global System for Mobile communications (GSM), Wideband Code Division Multiple Access (WCDMA) cellular communication network and the like.

According to some demonstrative embodiments of the invention, platform 100 may optionally include a storage unit 153, which may include, for example, a hard disk drive, a floppy disk drive, a Compact Disk (CD) drive, a CD-Recordable (CD-R) drive, or any other suitable removable and/or fixed storage unit.

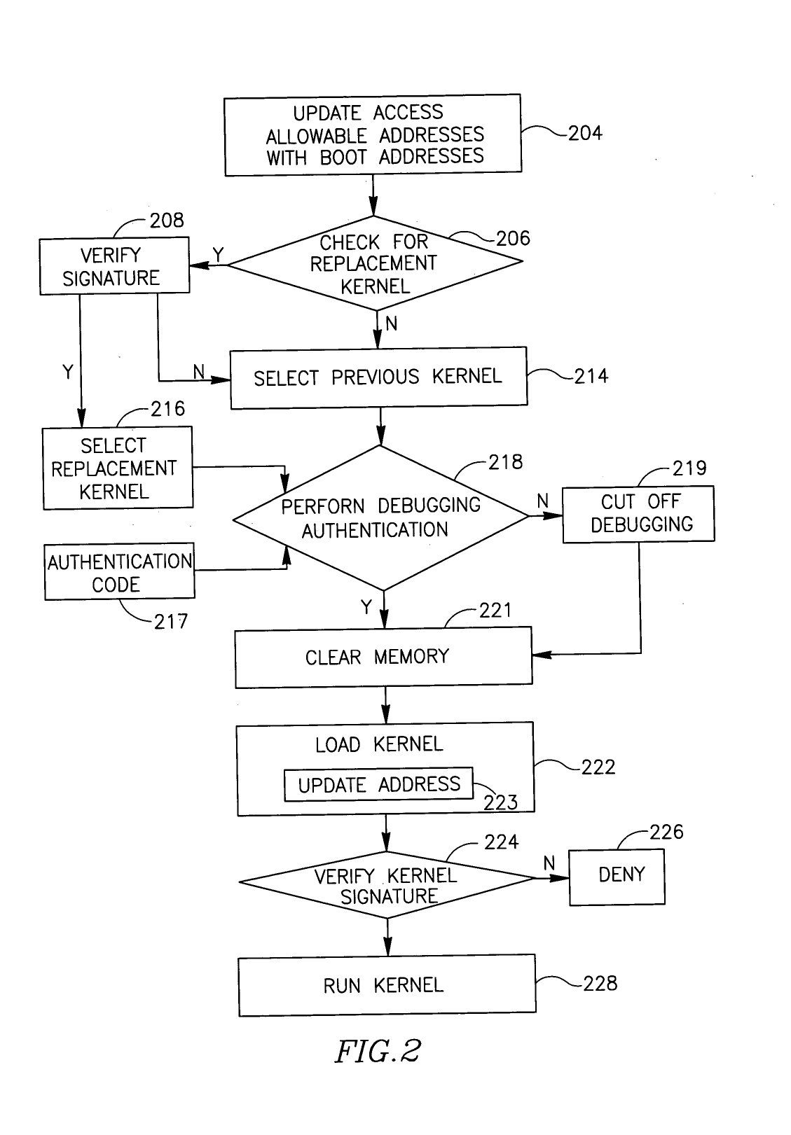

Reference is also made to FIG. 2, which schematically illustrates a method for loading a kernel according to some demonstrative embodiments of the invention.

Although the present invention is not limited in this respect, the method of FIG. 2 may be implemented by platform 100, e.g., during the Boot mode of operation.

Storage configuration 118 may not contain any values of access-allowable addresses, e.g., at the beginning of the boot mode of operation. Accordingly, access controller 124 may prevent processor 102 from accessing any addresses, e.g., including the addresses in which boot module 116 is stored. Thus, according to some demonstrative embodiments of the invention, it may be desired to update one or more access allowable addresses, e.g., in storage configuration 1118, in accordance with one or more addresses at which boot module 116 is stored.

As indicated at block 204, the method may include updating one or more access-allowable addresses corresponding to the address at which boot module 116 is stored.

As indicated at block 206, the method may include checking for a replacement version of the kernel (“the replacement kernel”). For example, OTA module 134 may check if the replacement kernel is stored in storage unit 153 or on any other suitable, e.g., local, storage module.

As indicated at block 208, the method may include verifying a signature of the replacement kernel, e.g., if the replacement kernel is detected. For example, OTA module 134 may utilize cryptographic module 122 to verify the signature of the replacement kernel.

As indicated at block 216, the method may include selecting the replacement kernel, e.g., if the signature of the replacement kernel is verified.

As indicated at block 214, the method may include selecting a previous kernel, e.g., a kernel 111 previously stored in ROM 135, e.g., if a replacement kernel is not detected or if a replacement kernel having an unverified signature is detected.

As indicated at block 217, the method may optionally include receiving or determining an authentication code, e.g., an HMAC value, corresponding to the value of register 161 and to a debugging attempt, as described above. The HMAC value may be stored, e.g., in register 162, for example, using authenticator 132 or a debugging authentication agent.

As indicated at block 218, the method may include performing a debugging authentication. For example, loader 128 may activate cutoff module 154 to compare the values of registers 161 and 162. The authentication may fail if the values of registers 161 and 162 do not match. The values of registers 161 and 162 may not match, for example, if debugging is not attempted or if the debugging attempt is not authentic.

According to some demonstrative embodiments, it may be indicated that the boot instructions, e.g., of module 116, have not been replaced by unauthorized and/or malicious instructions, e.g., if the debugging authentication is performed before the cycle-count value has reached the second value.

As indicated at block 219, the method may include cutting off any debugging, e.g., if the debugging authentication fails. For example, cut off module 154 may cut off any debugging connection, e.g., a JTAG connection, if the values of registers 161 and 162 do not match.

As indicated at block 221, the method may include clearing the memory; for example, kernel loader 128 may clear the contents of memory 106, e.g., before loading the selected kernel to the memory. Kernel loader 128 may implement any suitable method, e.g., as is known in the art, for clearing the memory

As indicated at block 222, the method may include loading the selected kernel to the memory. For example, kernel loader 128 may load the selected kernel, e.g., the replacement kernel or the previous kernel, to memory 106.

As indicated at block 223, the method may also include updating one or more access-allowable addresses in accordance with the addresses of the memory to which the selected kernel is loaded. For example, kernel loader 128 may update the values of registers 120 in accordance with the address ranges of memory 106 to which the selected kernel is loaded.

As described above, according to some demonstrative embodiments of the invention, the selected kernel may be stored in memory 108. According to these embodiments, the method may not include loading the kernel, which is already stored in memory 108. Loader 128 may update the values of registers 120 in accordance with the address ranges of memory 108 at which the selected kernel is stored.

As indicated at block 224, the method may include verifying the signature of the selected kernel, e.g., prior to running the selected kernel. For example, verifier 130 may utilize cryptographic module 122 to verify the signature of the selected kernel.

As indicated at block 228, the method may include running the selected kernel, e.g., if the signature of the kernel is verified.

As indicated at block 226, the method may include denying the kernel, stopping and/or re-booting computer platform 100, e.g., if the signature of the kernel is not verified. Alternatively, according to some embodiments, an unauthenticated kernel may be loaded; however, one or more elements of platform 100, e.g., cryptographic module 122, may be “locked”, e.g., by configuration 104, and certain resources may become unavailable. In these embodiments, platform 100 may operate in an unauthenticated mode with restricted use. For example, a user may be given the option to install an unauthenticated kernel but will lose ability to perform one or more activities, e.g., play DRM content or access certain financial services.

According to some demonstrative embodiments of the invention, an attack on the OS may include replacing one or more of the boot instructions of module 116 by one or more unauthorized and/or malicious instructions, e.g., as part of a debugging attempt. Thus, it may be desired to prevent bypassing of the protection of the OS, e.g., as described below.

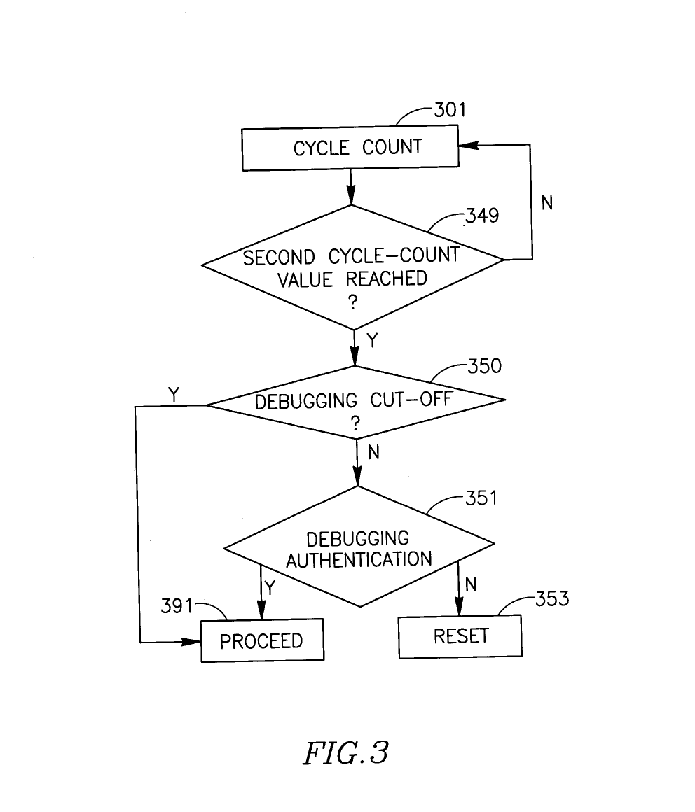

Reference is made to FIG. 3, which schematically illustrates a method of preventing an attempt to bypass one or more aspects of a protection scheme according to some demonstrative embodiments of the invention.

Although the present invention is not limited in this respect, the method of FIG. 3 may be implemented by platform 100, for example, to prevent an attempt to bypass, e.g., as part of a debugging attempt one or more aspects of the method described above with reference to FIG. 2.

As indicated at block 301, the method may include counting the number of CPU execution cycles performed, e.g., since power up. For example, upon power up counter 163 may start counting up/down from the first cycle-count value by decreasing/increasing the value of the stored cycle count, e.g., each CPU execution cycle, as described above.

As indicated at block 349, the method may also include checking if the cycle counter has reached the second cycle-count value.

As indicated at block 350, the method may include checking if the debugging possibility has been cut-off, e.g., if the second cycle-count value is reached. As indicated at block 291, the method may include proceeding, e.g., to perform any required operation, for example, if the debugging possibility has been cut off.

As indicated at block 351, the method may include performing debugging authentication, e.g., if the second cycle-count value is reached and the debugging possibility has not been cut-off. The authentication of the debugging attempt together with the cycle counter reaching the second cycle-count value may indicate that one or more of the boot instructions of module 106 have been replaced and/or overridden by an authentic and/or trusted debugging attempt. Thus, if the debugging is authenticated, the method may include proceeding, as indicated at block 391.

Failure of the debugging authentication after reaching the second cycle-count value may indicate that one or more of the boot instructions of module 116 have been replaced by one or more unauthorized and/or malicious instructions, e.g., as part of an attack on the OS. Thus, as indicated at block 353, the method may include resetting platform 100, e.g., if the debugging authentication has failed and the cycle counter has reached the second cycle-count value.

It will be appreciated by those skilled in the art that any combination of the above actions may be implemented for loading a kernel onto memory 106 according to embodiments of the invention. Further, other actions or series of actions may be used.

According to the above description, after verifying the signature of the selected kernel and after updating the access-allowable addresses according to the addresses at which the selected kernel is stored, the kernel stored in memory 106 and/or memory 108 may be assumed to be a trusted kernel, and the access to memory 106 and/or memory 108 may be controllably restricted to the access-allowable addresses, e.g., during the Kernel mode of operation, as described below.

Reference is now made to FIG. 4a, which schematically illustrates a method for controlling access to a memory according to a demonstrative embodiment of the invention.

Although the present invention is not limited in this respect, the method of FIG. 4a may be implemented by memory access control configuration 104 to control and/or restrict the access to memory 106 and/or memory 108, e.g., such that only certain instructions may be executed during the Kernel mode of operation.

As indicated at block 401, the method may include checking whether or not the mode of operation is a Kernel mode of operation, e.g., as described above.

As indicated at block 402, the method may include determining whether a memory address to which access is requested (“the requested address”) is an access-allowable address. For example, access controller 124 may compare an address in memory 106 or memory 108 indicated by PC 126, to the ranges of access-allowable addresses stored in registers 120.

As indicated at block 403, the method may include allowing execution of the instruction stored in the requested address. For example, memory access controller 124 may allow PC 126 to execute the instruction stored the requested address, e.g., in memory 106 or memory 108.

As indicated at block 404, the method may include preventing (denying) execution of an instruction stored in the requested address. For example, memory access controller 124 may prevent PC 126 from accessing an instruction stored in the requested address, e.g., if the requested address does not match or correspond to any access-allowable address.

Reference is now made to FIG. 4b, which schematically illustrates a method for controlling access to a memory according to another demonstrative embodiment of the invention.

Although the present invention is not limited in this respect, the method of FIG. 4b may be implemented by memory access control configuration 104 to control and/or restrict the access to memory 106 and/or 108, e.g., for performing one or more read and/or write operations. Although the present invention is not limited in this respect, the method of FIG. 4b may be implemented by memory access control configuration 104 additionally or alternatively to the method of claim 4a.

As indicated at block 420, the method may include determining whether or not the requested address is defined as a protected address. For example, access controller 124 may determine whether or not the requested address is defined as a protected address by checking the value of registers 120.

As indicated at block 422, the method may include allowing access to the requested address, e.g., to perform one or more read and/or write operations, for example, if the requested address is determined not to be a protected address.

According to some demonstrative embodiments of the invention, it may be desired to block peripherals from accessing one or more of the protected addresses. Thus, as indicated at block 424, the method may include determining whether or not the access attempt is by a peripheral. For example, controller 124 may determine whether or not the access attempt is received from processor 102 or from a peripheral. As indicated at block 426, the method may include denying and/or blocking access to the requested address, e.g., if the requested address is a protected address and the access attempt is by a peripheral.

As indicated at block 428, the method may include determining whether the requested address is an address corresponding to a kernel instruction or a private address. For example, controller 124 may check the value of one or more bits of register 127 to determine whether or not the requested address is a private address.

According to some demonstrative embodiment of the invention, it may be desired to allow reading kernel instructions, while preventing writing to the addresses containing kernel instructions. As indicated at block 430, the method may include determining whether or not the access attempt is for performing a read or write operation. The method may include denying an attempt to write to an address containing a kernel instruction, as indicated at block 432. The method may include selectively allowing an attempt to read from an address containing a kernel instruction, as indicated at block 434.

According to some demonstrative embodiments of the invention it may be desired that one or more operations are performed atomically, e.g., such that no other instructions and/or code may be executed between executing one or more instructions corresponding to the operation. This may be achieved and/or guaranteed, for example, by disabling interrupts and/or using semaphores, locks or any other synchronization primitives, e.g., as are known in the art.

According to some demonstrative embodiments of the invention, one or more sets of instructions 107 and/or instructions 109 may include atomic instructions intended to be executed atomically. Instructions 107 may include, for example, instructions resulting in updating one or more of the protected addresses, e.g., of registers 120. For example, instructions 107 may include instructions resulting in the following algorithm:

Algorithm 1

| approve_kernel_code(address, length) { | |
|---|---|
| 1. | if (verify_signature(address, length) == OK) |

| | |
|---|---|
| 2. | write_to_range_registers(address, address+length) |
| } | |

Algorithm 1 may be attacked, for example, in order to update registers 120 to enable executing one or more added kernel instructions stored in memory 106, e.g., without authenticating and/or verifying the added instructions. An attacker may, for example, execute Algorithm 1, while forcing the kernel to jump directly to line 2, thus bypassing the verification of the signature of the added instructions.

According to some demonstrative embodiments of the invention, the method may include determining whether the requested address corresponds to an address range of atomic instructions (“atomic range”), as indicated at block 468. For example, access controller 124 may determine that the requested address corresponds to an atomic range (“the requested atomic range”), if address register 120 is related to flag 119.

As indicated at block 469, the method may include allowing an attempt to read from the requested address, e.g., if the requested address is not an atomic address, as indicated at block 434.

According to some demonstrative embodiments of the invention, the method may include enabling the attempt to access the requested address if, for example, the requested address corresponds to the atomic entry-point, or a previous attempt to enter another address within the requested atomic range was allowed. For example, the method may include denying and/or preventing the attempt to access the requested address, e.g., by resetting the computing system, for example, if both the requested address does not correspond to the atomic entry-point, and the atomic flag is set to the flag up mode, e.g., as described below.

According to some demonstrative embodiments of the invention, the method may include determining whether the requested address corresponds to the atomic entry point of the requested atomic range, as indicated at block 470. For example, access controller 124 may determine whether the requested address matches or corresponds to an address, e.g., the first address in the requested atomic range, corresponding to the atomic entry point.

According to some demonstrative embodiments of the invention, the method may include setting the atomic flag to the flag up mode, if the requested address matches or corresponds to the atomic entry point of the requested atomic range, as indicated at block 471. For example, access controller 124 may set the mode of flag 119 to the flag up-mode, e.g., only if the requested address matches or corresponds to the atomic entry point of the requested atomic range.

As indicated at block 472, according to some demonstrative embodiments of the invention, the method may include determining whether or not the flag corresponding to the requested atomic range is in the flag up mode, e.g., if the requested address does not match or correspond to the atomic entry point of the requested atomic range.

According to some demonstrative embodiments of the invention, the attempt to access the requested address, when both the requested address does not match the atomic entry point, and the flag corresponding to the requested atomic range is set to the flag down mode, may indicate that the attempt is unauthorized, and/or unverified, e.g., an attack attempt. Accordingly, as indicated at block 474, the method may include denying and/or preventing the attempt to access the requested address, e.g., by resetting the computing platform, for example, if both the requested address does not match the atomic entry point; and the flag is set to the flag down mode.

As indicated at block 473, the method may include allowing access to the requested address, e.g., if the flag is set to the flag up mode, and/or the requested address matches the atomic entry point.

According to some demonstrative embodiments of the invention, the instructions stored in the atomic address range may include instructions for setting the flag to the down mode of operation, e.g., at the end of the atomic operation; to disable interrupts during the execution of the atomic instructions; and/or to re-enable interrupts, e.g., at the end of the atomic operation.

According to some demonstrative embodiments of the invention, instructions 107 may include, for example, instructions resulting in the following algorithm:

Algorithm 2

| approve_kernel_code_atomically(address, length) { | |
|---|---|
| 1. | disable_interrupts( ) |
| 2. | if (verify_signature(address, length) == OK) |

| | |
|---|---|
| 3. | write_to_range_registers(address, address+length) |

| | |
|---|---|
| 4. | clear_atomic_flag( ) |
| 5. | enable_interrupts( ) |
| } | |

According to some demonstrative embodiments of the invention, an attempt to begin executing Algorithm 2 from any instruction other than the first instruction may result in the resetting of the computing platform.

Although the above description relates to a method of executing kernel instructions, it will be appreciated by those skilled in the art that in other embodiments of the invention the method may be implemented to protect ant other desired instruction and/or data, for example, private data, e.g., an MMU table. For example, the desired instruction and/or data may be marked by a corresponding atomic flag; and instructions 107 and/or 109 may be adapted to enable accessing the instruction and/or data within a kernel-range marked as atomic.

Although the invention is not limited in this respect, it may be desired to implement a single atomic range. The atomic range may be used as a dispatcher for one or more atomic operations. Atomic instructions relating to the atomic operations may be stored in protected addresses, and may be adapted to be executed with interrupts disabled. The dispatcher may be executed from the atomic range, disable interrupts, call an atomic function referenced by a value provided by the caller, clear the atomic flag, re-enable interrupts, and return the result of the atomic function.

As indicated at block 440, the method may include determining whether or not the access attempt is performed as part of an executed instruction having a trust level adequate for accessing the requested address. For example, controller 124 may compare the trust level value corresponding to the requested address with the trust level value corresponding to the instruction for accessing the requested address, e.g., as may be stored in register 129 as described above. The method may include allowing an attempt to access the requested address if the trust level of the executed instruction is adequate for accessing the requested address, as indicated at block 438. The method may include denying an attempt to access the requested address if the trust level of the executed instruction is not adequate for accessing the requested address, as indicated at block 436.

It will be appreciated by those skilled in the art that any combination of the above actions may be implemented for controlling access to a memory according to embodiments of the invention. Further, other actions or series of actions may be used.

Reference is made to FIG. 5, which conceptually illustrates a kernel configuration 500, according to some demonstrative embodiments of the invention.

Although the present invention is not limited in this respect, configuration 500 may be implemented by one or more of kernel instructions 107 (FIG. 1).

According to some demonstrative embodiments of the invention, configuration 500 may include a module loader 502 able to add to kernel instructions 107 one or more additional kernel instructions, e.g., corresponding to one or more added modules, programs and/or device-drivers, as known in the art. Module loader 502 may also be able to add to the access-allowable addresses stored in storage 118 one or more access-allowable addresses corresponding to the address of the added kernel instructions. For example, module loader 502 may be able to update one or more registers 120 with address range values corresponding to the addresses of the added kernel instructions. Module 502 may also be able to delete one or more of the added access-allowable addresses from storage 120, e.g., if one or more of the added modules, programs and/or device-drivers are unloaded.

According to some demonstrative embodiments of the invention, kernel configuration 500 may include a Memory Manager (MM) module 504, e.g., as is known in the art. According to some demonstrative embodiments MM module 504 may be implemented by kernel instructions stored in one or more trust-protected addresses, as are described above. Module 504 may designate one or more of the access-allowable addresses, e.g., the addresses corresponding to MMU tables, as private addresses.

According to some demonstrative embodiments of the invention, kernel configuration 500 may include an OTA kernel handler 506 able to receive a replacement kernel. Handler 506 may be able to verify a signature of the received replacement kernel, e.g., utilizing cryptographic module 122. OTA handler 506 may store the replacement kernel, e.g., in storage 153, for example, if the signature of the replacement kernel is verified. OTA handler 506 may optionally be able to reboot the computing platform, such that the replacement kernel may be loaded during the boot sequence. Alternatively, OTA handler 506 may not reboot the computing platform, and the replacement kernel may later be loaded, e.g., when the system is rebooted by the user.

Reference is made to FIG. 6, which conceptually illustrates a debugger authentication configuration 600 according to some demonstrative embodiments of the invention.

Configuration 600 may include a server 610 to associate a debugger 616, e.g., an AXD debugger as is known in the art, with a computing platform 602, e.g., including computing platform 100 as described above with reference to FIG. 1. Configuration 600 may also include a multi-ICE module to associate server 610 with platform 602, for example, using a first connection 604, e.g., a JTAG connection, and a second connection, e.g., a parallel connection, as is known in the art.

Server 610 may include a service 614 including one or more instructions to communicate with Multi-ICE module 606 and debugger 616, e.g., as known in the art.

According to some demonstrative embodiments of the invention server 610 may include an authentication agent 612, e.g., implemented by one or more instructions executable by server 610, Agent 612 may be able to utilize service 614 to detect a power-cycle of debugger 616. Agent 612 may be able to utilize service 614 to read the value stored in register 161 (FIG. 1), e.g., when a power-cycle is detected. Agent 612 may then communicate with an external authentication token, e.g., via a network connection or a USB token of server 610, to receive an authentication value, e.g., an HMAC value, corresponding to the value of register 161 (FIG. 1). Agent 612 may further utilize service 614 to write the authentication value to register 162 (FIG. 1). It will be appreciated by those skilled in the art that according to these demonstrative embodiments of the invention the authentication of debugger 616 may be performed by agent 612 in a manner transparent to debugger 616. According to some demonstrative embodiments, agent 612 may utilize service 614 to stop (“freeze”) operation of platform 602, e.g., between receiving the value of register 161 (FIG. 1) and writing the authenticated value to register 162 (FIG. 1), for example, in order to prevent cycle counter 163 (FIG. 1) from reaching the second cycle-count value, as described above.

According to some demonstrative embodiments of the invention, agent 612 may also include a user-interface, e.g., to allow a user to receive the value of register 161 (FIG. 1) and/or to enter the authentication value corresponding to the value of register 161 (FIG. 1) manually. This may be desired, for example, when using a proprietary debugger, which may execute one or more boot instructions different than the boot instructions of module 116 (FIG. 1). In such case, the user may be able to manually copy the value from register 161 (FIG. 1) and update register 162 (FIG. 1) with the response it gets using the user-interface. This may also be desired, for example, if a user, e.g., a field technician, does not have access to an authentication token. In such case, the technician may, for example, call a call-center, identify herself properly, give the call-center the value of register 161 (FIG. 1), e.g., received from agent 612, and the call-center may provide the technician with a corresponding authentication code to be written to register 162 (FIG. 1).

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art it is, therefore, to be understood that the appended claims are intended to cover all such modifications and changes as fall within the true spirit of the invention.

What is claimed is:

1. An apparatus of securing an operating system, the apparatus comprising:
a memory access controller to receive from a processor a program counter representing a requested address of a memory to be accessed by said processor during a kernel mode of operation, and to selectively enable said processor to access said requested address based on a comparison between said requested address and one or more allowable addresses.

2. The apparatus of claim 1, wherein said memory access controller is able to enable said processor to access said requested address during said kernel mode only if said requested address corresponds to one of said allowable addresses.

3. The apparatus of claim 1 comprising a storage to store one or more address values identifying said one or more allowable addresses.

4. The apparatus of claim 3 comprising a boot module to update said address values during a boot process to identify one or more memory addresses including boot instructions.

5. The apparatus of claim 4, wherein said boot module is able to store one or more kernel instructions in one or more addresses of said memory during said boot process, wherein said controller is able to update said address values to identify the addresses of said kernel instructions.

6. The apparatus of claim 4, wherein said boot module is able to verify said kernel instructions, and to enable said processor to execute said kernel instructions only if said kernel instructions are verified.

7. The apparatus of claim 3 comprising a debugging controller to perform an authentication of an attempt to operate said processor at a debugging mode, and to disable a debugging connection to said processor if said authentication fails.

8. The apparatus of claim 7, wherein said debugging controller comprises a cycle counter to maintain a cycle value indicating a number of execution cycles performed by said processor.

9. The apparatus of claim 8, wherein said cycle value indicates a number of execution cycles performed by said processor since power-up.

10. The apparatus of claim 8, wherein if the number of execution cycles indicated by said cycle value is bigger than an allowed number of execution cycles, said debugging controller is able to perform an authentication of said attempt, and to reset the operation of said processor if said authentication fails.

11. The apparatus of claim 3, wherein said allowable addresses include one or more private addresses, said secure storage stores one or more type values indicating whether one or more of said allowable addresses include private data, and wherein said memory access controller is able to selectively enable said processor to access said requested address based on a type value of a private address corresponding to said requested address.

12. The apparatus of claim 11, wherein said secure storage stores one or more trust values indicating a required trust level for accessing one or more of said allowable addresses, and wherein said memory access controller is able to enable said processor to access said requested address if a trust level corresponding to a memory address of an instruction resulting in said requested address complies with a required trust level indicated by the trust value of a private address corresponding to said requested address.

13. The apparatus of claim 3, wherein said allowable addresses include at least one atomic address range having an entry-point address; and wherein, if said requested corresponds to said atomic address range, said access controller enables access to said requested address if said requested address corresponds to said entry-point address, or if a previously accessed address corresponded to said atomic address range.

14. The apparatus of claim 12, wherein said storage stores a flag to be set to either a flag-up mode or a flag-down mode, wherein said controller is able to set said flag to said flag-up mode if said requested address corresponds to said entry-point.

15. The apparatus of claim 1, wherein one or more of said allowable addresses maintain one or more kernel instructions to be executed by said processor during said kernel mode.

16. A method of securing an operating system, the method comprising:
receiving from a processor a program counter representing a requested address of a memory to be accessed by said processor during a kernel mode of operation; and
selectively enabling said processor to access said requested address based on a comparison between said requested address and one or more allowable addresses.

17. The method of claim 16, wherein said selectively enabling comprises enabling said processor to access said requested address during said kernel mode only if said requested address corresponds to one of said allowable addresses.

18. The method of claim 16 comprising maintaining one or more address values identifying said one or more allowable addresses.

19. The method of claim 16 comprising during a boot process, updating said address values to identify one or more memory addresses including boot instructions.

20. The method of claim 19 comprising, during said boot process:
storing one or more kernel instructions in one or more addresses of said memory; and
updating said address values to identify the addresses of said kernel instructions.

21. The method of claim 19 comprising:
verifying said kernel instructions; and
enabling said processor to execute said kernel instructions only if said kernel instructions are verified.

22. The method of claim 18 comprising:
performing an authentication of an attempt to operate said processor at a debugging mode; and
disabling a debugging connection to said processor if said authentication fails.

23. The method of claim 22 comprising maintaining a cycle value indicating a number of execution cycles performed by said processor.

24. The method of claim 23, wherein maintaining said cycle value comprises maintaining a cycle value indicating a number of execution cycles performed by said processor since power-up.

25. The method of claim 23 comprising, if the number of execution cycles indicated by said cycle value is bigger than an allowed number of execution cycles, performing an authentication of said attempt, and resetting the operation of said processor if said authentication fails.

26. The method of claim 18 wherein maintaining said allowable addresses comprises maintaining one or more private addresses, said method comprises:
maintaining one or more type values indicating whether one or more of said allowable addresses include private data; and
selectively enabling said processor to access said requested address based on a type value of a private address corresponding to said requested address.

27. The method of claim 26 comprising:
maintaining one or more trust values indicating a required trust level for accessing one or more of said allowable addresses; and
enabling said processor to access said requested address if a trust level corresponding to a memory address of an instruction resulting in said requested address complies with a required trust level indicated by the trust value of a private address corresponding to said requested address.

28. The method of claim 18, wherein said allowable addresses include at least one atomic address range having an entry-point address; and wherein, said method includes, if said requested corresponds to said atomic address range:
enabling access to said requested address if said requested address corresponds to said entry-point address, or if a previously accessed address corresponded to said atomic address range.

29. The method of claim 28 comprising:
maintaining a flag to be set to either a flag-up mode or a flag-down mode; and
setting said flag to said flag-up mode if said requested address corresponds to said entry-point.

30. A computing platform comprising:
a processor to generate a program counter representing a requested address of a memory to be accessed by said processor during a kernel mode of operation; and
a memory access controller to receive said program counter from said processor, and to selectively enable said processor to access said requested address based on a comparison between said requested address and one or more allowable addresses.

31. The computing platform of claim 30, wherein said memory access controller is able to enable said processor to access said requested address during said kernel mode only if said requested address corresponds to one of said allowable addresses.

32. The computing platform of claim 30 comprising a storage to store one or more address values identifying said one or more allowable addresses.

33. The computing platform of claim 32 comprising a boot module to update said address values during a boot process to identify one or more memory addresses including boot instructions.

34. The computing platform of claim 32 comprising a debugging controller to perform an authentication of an attempt to operate said processor at a debugging mode, and to disable a debugging connection to said processor if said authentication fails.

35. The computing platform of claim 32, wherein said allowable addresses include one or more private addresses, said secure storage stores one or more type values indicating whether one or more of said allowable addresses include private data, and wherein said memory access controller is able to selectively enable said processor to access said requested address based on a type value of a private address corresponding to said requested address.

36. The computing platform of claim 32, wherein said allowable addresses include at least one atomic address range having an entry-point address; and wherein, if said requested corresponds to said atomic address range, said access controller enables access to said requested address if said requested address corresponds to said entry-point address, or if a previously accessed address corresponded to said atomic address range.
